(19) United States
(12) Patent Application Publication
(10) Pub. No.: US 2025/0249593 A1
(43) Pub. Date: Aug. 7, 2025

(54) Simultaneous Multi-Ply Lamination Equipment End Effector

(71) Applicant: The Boeing Company, Arlington, VA (US)

(72) Inventors: Austin B. Ball, Mercer Island, WA (US); Shuonan Dong, Seattle, WA (US); Alan Scott Locke, Federal Way, WA (US); Asher Seth Einhorn, Seattle, WA (US)

(21) Appl. No.: 18/435,891

(22) Filed: Feb. 7, 2024

(51) Int. Cl. B25J 9/16; B29C 70/38

(52) U.S. Cl. CPC B25J 9/1697; B29C 70/38

(57) ABSTRACT

A course placement system comprising a frame and a contact surface layer. The frame comprises a first rectangular shape and a second rectangular shape partially overlapping the first rectangular shape at an angle to the first rectangular shape. The contact surface layer is connected to the frame. The contact surface layer has a surface area shape within the frame.

### CROSS-REFERENCE TO RELATED APPLICATION

This application is related to the following U.S. patent application Ser. No. 18/450,921, filed Aug. 16, 2023, entitled “Multi-Ply Lamination System,” attorney docket no. 23-0237-US-NP, assigned to the same assignee, and incorporated herein by reference in its entirety.

### BACKGROUND INFORMATION

### 1. Field

The present disclosure relates generally to composite manufacturing and in particular, manipulating courses using end effectors.

### 2. Background

Aircraft are being designed and manufactured with greater and greater percentages of composite materials. Composite materials are used in aircraft to decrease the weight of the aircraft. This decreased weight can improve performance features such as payload capacity and fuel efficiency. Further, composite materials provide longer service life for various components in an aircraft.

Composite materials can be tough, light-weight materials created by combining two or more functional components. For example, a composite material can include reinforcing fibers bound in a polymer resin matrix, such as a carbon fiber reinforced polymer (CFRP). The fibers can be unidirectional, such as a tape or a tow, or can be multidirectional, such as a woven cloth or fabric. The fibers and resins can be arranged and cured to form a composite structure.

Using composite materials to create aerospace composite structures can allow for portions of an aircraft to be manufactured in larger pieces or sections. For example, a fuselage in an aircraft can be created in cylindrical sections to form the fuselage of the aircraft. Other examples include, without limitation, wing components joined to form a wing or stabilizer components joined to form a stabilizer.

In manufacturing composite structures, layers of composite material can be laid up on a tool. The layers of composite material may include fibers in sheets. These sheets can take the form of, for example, without limitation, fabrics, tape, tows, or other suitable configurations for the sheets. In some cases, resin can be infused or pre-impregnated into the sheets. These types of sheets are commonly referred to as prepreg.

The different layers of prepreg can be laid up in different orientations and different numbers of layers can be used depending on the desired thickness of the composite structure being manufactured. These layers can be laid up by hand or using automated lamination equipment such as tape laminating machines or fiber placement systems. When using automated equipment, pieces of material referred to as courses are picked up and placed by placement robots having end effectors.

### SUMMARY

An embodiment of the present disclosure provides a course placement system comprising a frame and a contact surface layer. The frame comprises a first rectangular shape and a second rectangular shape partially overlapping the first rectangular shape at an angle to the first rectangular shape. The contact surface layer is connected to the frame. The contact surface layer has a surface area shape within the frame.

Another embodiment of the present disclosure provides a course placement system comprising placement robots and end effectors connected to the placement robots. Each of the end effectors comprises a frame and a contact surface layer. The frame comprises a first rectangular shape and a second rectangular shape partially overlapping the first rectangular shape at an angle to the first rectangular shape that forms a six pointed star shape. The contact surface layer is connected to the frame. The contact surface layer has a surface area shape within the frame.

Still another embodiment of the present disclosure provides a method for placing courses. The courses for a ply are identified. Placement robots with end effectors are simultaneously moved to place the courses for the ply in a first pass without collisions between the end effectors. Each of the end effectors comprises a frame with a contact surface layer. The frame comprises a first rectangular shape and a second rectangular shape partially overlapping the first rectangular shape at an angle to the first rectangular shape in which the contact surface layer is connected to the frame and has a surface area shape within the frame.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a composite manufacturing environment in accordance with an illustrative embodiment;

FIG. 2 is an illustration of a block diagram of an end effector in accordance with an illustrative embodiment;

FIG. 3 is an illustration of an end effector shown in a perspective view in accordance with an illustrative embodiment;

FIG. 4 is an illustration of an exploded view of an end effector in accordance with an illustrative embodiment;

FIG. 5 is an illustration of a frame in accordance with an illustrative embodiment;

FIG. 6 is an illustration of a contact surface layer in accordance with an illustrative embodiment;

FIG. 7 is an illustration of a pocket plate in accordance with an illustrative embodiment;

FIG. 8 is an illustration of course orientations in accordance with an illustrative embodiment;

FIG. 9 is an illustration of fiducial patterns in accordance with an illustrative embodiment;

FIG. 10 is a schematic illustration of spacing of placement robots in accordance with an illustrative embodiment;

FIG. 11 is an illustration of end effector shapes in accordance with an illustrative embodiment;

FIG. 12 is an illustration of a flowchart of a process for placing courses in accordance with an illustrative embodiment;

FIG. 13 is an illustration of a flowchart of a process for simultaneously moving placement robots with end effectors in accordance with an illustrative embodiment;

FIG. 14 is an illustration of a block diagram of an aircraft manufacturing and service method in accordance with an illustrative embodiment; and

FIG. 15 is an illustration of a block diagram of an aircraft in which an illustrative embodiment may be implemented.

### DETAILED DESCRIPTION

The illustrative embodiments recognize and take into account one or more different considerations as described herein. For example, courses can be laid up side by side using multiple placement robots with end effectors to form a ply. These placement robots typically are positioned in an array. The placement robots can operate simultaneously to pick up and place the courses.

Currently, end effectors have shapes and dimensions that may impose limits on how closely the placement robots can be located next to one another in an array, and/or in how adjacent placement robots in an array coordinate their pick and place operations, in order to avoid collisions in placing these courses onto a layup surface as the length of the courses become shorter. For example, the illustrative embodiments also recognize and take into account that simultaneously picking up courses with a 90° orientation and placing those courses onto a layup surface can result in collisions between the end effectors on the placement robots, if the robots are positioned too closely to each other in the array.

One solution involves using the first alternating placement robots to place first courses and then using second alternating placement robots to place second courses. This type of placement increases the number of pick and place operations. Further, this type of placement also increases the time needed to place courses to form a ply.

Thus, illustrative embodiments provide a method, apparatus, and system for placing courses using placement robots with end effectors. In one illustrative example, a course placement system comprises a frame and a contact surface layer connected to the frame. The frame comprises a first rectangular shape and a second rectangular shape partially overlapping the first rectangular shape at an angle to the first rectangular shape. This shape of the end effector has dimensions that enable picking and placing courses of different orientations in a manner that enables placement robots to be located closer to each other to pick and place courses in a manner that avoids collisions between end effectors when the placement robots perform simultaneous placement of the courses.

In one illustrative example, an end effector having a shape optimized for picking and placing courses of different orientations is desirable. The shape and dimensions are selected to enable picking and placing courses of different orientations.

For example, if the courses are cut from a roll of material in the form of broad goods, the fibers in the courses may initially be in an orientation aligned with the direction of the material as rolled (sometimes referred to as a 0 degree orientation), and then rotated by the placement robots and placed so that the fibers have a desired orientation.

This desired orientation can be, for example, 45 degrees relative to the initial orientation. Desired orientations for courses can be selected from a group consisting of 15 degrees, 30 degrees, 45 degrees, 60 degrees, 75 degrees, 90 degrees, and other orientations relative to the initial orientation. Being relative to the initial orientation means that these degrees can be positive or negative values. The desired orientations can be determined from a design or other information specifying orientations for courses used to form a ply.

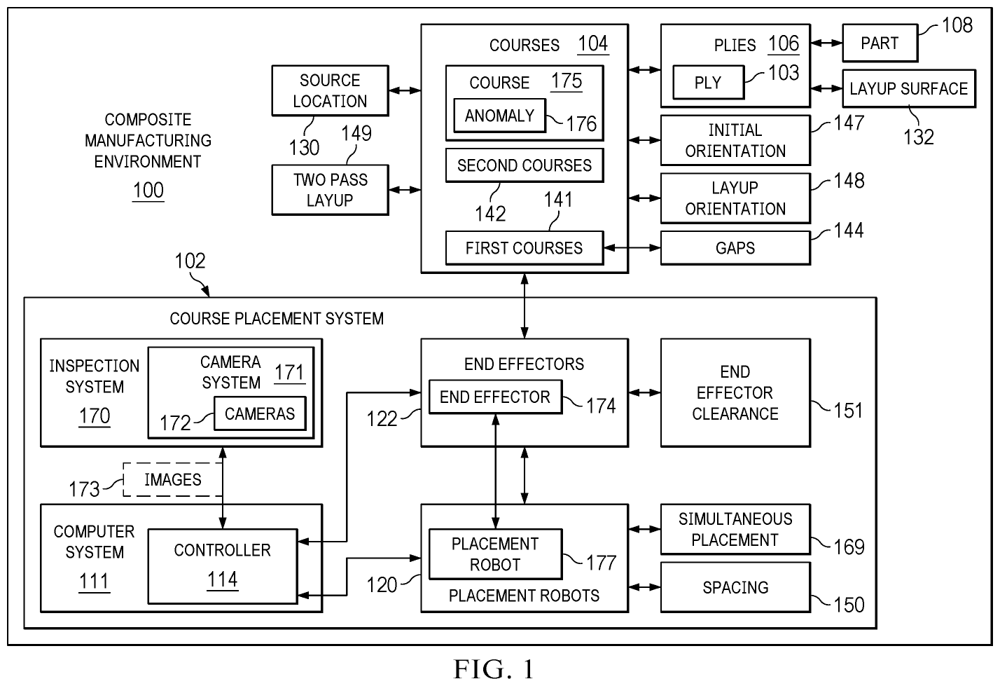

With reference now to FIG. 1, an illustration of a block diagram of a composite manufacturing environment is depicted in accordance with an illustrative embodiment. In this example, course placement system 102 in composite manufacturing environment 100 operates to layup courses 104 to form a number of plies 106 on layup surface 132.

As used herein, a course is a single piece of a cut material. Ply 103 in the number of plies 106 is a series of courses 104 having the same fiber orientation that are laid up or placed next to each other to form a layer that is ply 103. As used herein, “a number of” when used with reference to items, means one or more items. For example, “a number of plies 106” is one or more plies.

These number of plies 106 are used to manufacture part 108. Part 108 can be selected from a group comprising an elongate composite part, a wing stringer, a fuselage stringer, an empennage stringer, a floor beam, a wing spar, and an empennage spar. This part can be comprised completely of composite materials or can be a mix of composite materials with non-composite materials.

In this example, course placement system 102 comprises a number of different components. As depicted, course placement system 102 comprises placement robots 120, end effectors 122, and controller 114. Placement robots 120 may be arranged relative to each other in an array, such as in a line, or some other configuration, for example in a production cell in a factory or other production facility.

In this example, end effectors 122 are connected to placement robots 120. Also in this example, each end effector in end effectors 122 is connected to a placement robot in placement robots 120.

Controller 114 is in communication with placement robots 120 and controls the operation of placement robots 120 and end effectors 122.

In this illustrative example, controller 114 can be a centralized component in a single location or can be distributed. When distributed, controller 114 can be distributed in at least one of placement robots 120 or end effectors 122.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Further, controller 114 can be implemented in software, hardware, firmware, or a combination thereof. When software is used, the operations performed by controller 114 can be implemented in program instructions configured to run on hardware, such as a processor unit. When firmware is used, the operations performed by controller 114 can be implemented in program instructions and data can be stored in persistent memory to run on a processor unit. When hardware is employed, the hardware can include circuits that operate to perform the operations in controller 114.

In the illustrative examples, the hardware can take a form selected from at least one of a circuit system, an integrated circuit, an application specific integrated circuit (ASIC), a programmable logic device, a processor unit, a single core processor, a dual-core processor, a multi-processor core, a general-purpose central processing unit (CPU), a digital signal processor (DSP), or some other suitable type of hardware configured to perform a number of operations. With a programmable logic device, the device can be configured to perform the number of operations. The device can be reconfigured at a later time or can be permanently configured to perform the number of operations.

Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 111 is a physical hardware system and includes one or more data processing systems. When more than one data processing system is present in computer system 111, those data processing systems are in communication with each other using a communications medium. The communications medium can be a network.

In this illustrative example, controller 114 controls the operation of placement robots 120 to pick up courses 104 from source location 130 and place courses 104 onto layup surface 132 using end effectors 122. Controller 114 controls placement robot 177 to change courses 104 from initial orientation 147 to layup orientation 148 and place courses 104 onto layup surface 132 in the layup orientation.

Source location 130 can be, for example, a table, a conveyor, a cart, a platform, a bin, a drawer, or some other location in which courses 104 can be located for placement onto layup surface 132. In this illustrative example, layup surface 132 can be a table, a conveyor, a cart, a platform, or some other surface on which courses 104 can be placed. In this example, layup surface 132 can also be a surface of ply 103 or other layer or component for part 108.

In one illustrative example, controller 114 can control placement robots 120 to perform simultaneous placement 169 of courses 104 onto layup surface 132 with spacing 150 of robots that provides end effector clearance 151 between end effectors 122 that avoids collisions between end effectors 122 during the simultaneous placement of courses 104 onto layup surface 132. In this example, end effector clearance 151 is based on dimensions of the surface area shape of the end effectors.

With this example, courses 104 are placed on the layup surface 132 in two pass layup 149 of courses 104 to form ply 103. In other words, simultaneous placement 169 of courses 104 onto layup surface 132 for ply 103 occurs in two passes performed by placement robots 120 which some of courses 104 are placed on layup surface 132 in each pass.

For example, placement robots 120 use end effectors 122 to place first courses 141 in courses 104 in every other location on layup surface 132 in a first pass in two pass layup 149. This placement of first courses 141 leaves gaps 144 between first courses 141. These courses can also be referred to as first spaced courses. Gaps 144 between these courses are filled by second courses 142 in courses 104 that are placed in a second pass in two pass layup 149 by placement robots 120 using end effectors 122. These courses can also be referred to as second spaced courses.

Further, course placement system 102 can also include inspection system 170 that is configured to inspect second courses 142. This inspection can be performed at different locations from source location 130 to layup surface 132 including locations between the two locations.

In this illustrative example, inspection system 170 can include a number of different components. For example, inspection system 170 can comprise at least one of a camera system, a thermal camera, an infrared light camera, a visible light camera, a laser scanner, an x-ray imaging machine, a laser stereography system, or some other suitable inspection system.

In this example, inspection system 170 comprises camera system 171. Camera system 171 comprises a number of cameras 172. Camera system 171 is configured to generate a number of images 173 of end effector 174 in end effectors 122 holding course 175 in courses 104. In this example, end effector 174 is connected to placement robot 177 in placement robots 120. Camera system 171 sends the number of images 173 to controller 114.

As depicted, controller 114 in computer system 111 analyzes the number of images 173 for anomaly 176 in course 175 that is out of tolerance. In one illustrative example, anomaly 176 is the positioning of course 175 on end effector 174. With this example, controller 114 controls placement robot 177 in placement robots 120 to change the positioning of the course in response to the course having a positioning that is out of tolerance. This change is performed to have course 175 in the desired position for placement onto layup surface 132.

In another illustrative example, anomaly 176 is an inconsistency in course 175 and is out of tolerance. For example, anomaly 176 can be at least one of foreign debris (FOD), wrinkles, pockets, imperfections, frayed edges, inconsistencies in the material, or other type of anomaly 176 in course 175. With this illustrative example, controller 114 controls placement robot 177 to move course 175 to a scrap location. Controller 114 also initiates a process to generate a replacement course.

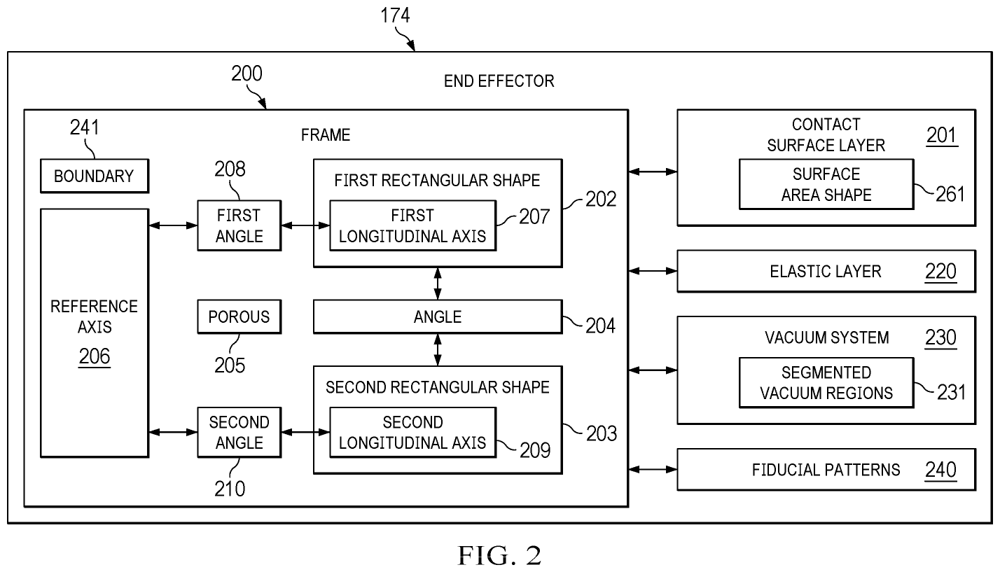

Turning next to FIG. 2, an illustration of a block diagram of an end effector is depicted in accordance with an illustrative embodiment. In this illustrative example, components that can be present in end effector 174 are shown. In the illustrative examples, the same reference numeral may be used in more than one figure. This reuse of a reference numeral in different figures represents the same element in the different figures.

In this example, end effector 174 comprises frame 200 and contact surface layer 201. Contact surface layer 201 is connected to frame 200. When one component is “connected” to another component, the connection is a physical connection.

For example, a first component, contact surface layer 201, can be considered to be physically connected to a second component, frame 200, by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both. In some examples, the first component can be physically connected to the second component by being located within the second component.

In this example, frame 200 comprises first rectangular shape 202 and a second rectangular shape 203 overlapping first rectangular shape 202 at angle 204 to first rectangular shape 202. In this illustrative example, the “overlapping” is “partially overlapping” and not “completely overlapping.” In other words, boundary 241 for frame 200 is formed by these two partially overlapping shapes.

In one illustrative example, contact surface layer 201 is connected to frame 200. Further, in this example, contact surface layer 201 has surface area shape 261 within frame 200. By being within frame 200, surface area shape 261 can correspond or substantially match the shape and dimensions of boundary 241 for frame 200. In another example, surface area shape 261 can have a different shape than boundary 241. For example, surface area shape 261 can be defined by first rectangular shape 202 and a second rectangular shape 203 in which first rectangular shape 202 has a notch at the ends of first rectangular shape 202. Contact surface layer 201 is porous 205 and can be a porous polyethylene.

In this example, reference axis 206 extends through frame 200. First longitudinal axis 207 extends centrally though first rectangular shape 202. In this example, first longitudinal axis 207 intersects reference axis 206 at first angle 208. Further in this example, second longitudinal axis 209 extends through second rectangular shape 203, and second longitudinal axis 209 intersects reference axis 206 at second angle 210. In one illustrative example, first angle 208 is 90 degrees and second angle 210 is 45 degrees.

In this example, second rectangular shape 203 can be configured to pick and place 90 degree courses. First rectangular shape 202 can be configured to pick and place one of 45 degrees courses, −45 degree courses, and 0 degree courses.

In this illustrative example, the overlap between first rectangular shape 202 and second rectangular shape 203 is a partial overlap such that two diagonally opposed corners of one rectangle sit on or within the four edges of the other rectangle. With these partially overlapping rectangular shapes, frame 200 has boundary 241 with a shape of a six pointed star.

In this example, the elastic layer 220 is connected to frame 200. Elastic layer 220 can enable contact surface layer 201 to conform to ply drops or other changes in contour, for example in courses that have been placed. This layer can also be used to compact courses 104. In this illustrative example, elastic layer 220 can be at least one of a foam, an open cell foam, a closed cell foam, a polyurethane foam, a memory foam, an elastomer, or other suitable materials.

In this example, end effector 174 can also include vacuum system 230 connected to frame 200. In this example, vacuum system 230 has segmented vacuum regions 231. Vacuum system 230 operates to generate a vacuum to pick up and hold courses 104. In this example, regions in segmented vacuum regions 231 can be selectively enabled to pick up and hold courses 104. For example, one or more regions in segmented vacuum regions 231 can be active in generating a vacuum. These regions can be selected to have an area with a shape and dimensions that substantially correspond to the shape and dimensions of courses 104. As a result, vacuum loss can be reduced. Further, this selection of segmented vacuum regions 231 can also reduce or avoid disturbing nearby courses that have already been placed.

In some illustrative examples, end effector 174 has a number of fiducial patterns 240 connected to frame 200. In other illustrative examples, fiducial patterns 240 can be placed in other locations in addition to or in place of being located on frame 200. For example, fiducial patterns 240 can be placed on contact surface layer 201.

The number of fiducial patterns 240 are markers that have a shape arranged in a pattern on end effector 174. In other words, each marker can have in the markers can be arranged in a pattern. Shape and size of each marker can be the same or different from other markers. In this example, the number of fiducial patterns can be located on the edge of frame 200.

These fiducial patterns can provide a localized coordinate system. Further, each fiducial pattern can include information to uniquely identify that pattern from other patterns in the number of fiducial patterns 240. For example, when a fiducial pattern is comprised of dots, the positions of the dots can uniquely identify each pattern in the number of fiducial patterns 240. In another illustrative example, fiducial patterns 240 can be comprised of barcodes, QR codes, block patterns, April tags, or other suitable types of indicia or visual cues.

The illustration of components for end effector 174 is an example of some components that can be implemented in end effector 174. The illustration of these components is not meant to limit what components can be used in end effector 174 in other illustrative examples. Other components in addition to or in place of these components may be used. For example, in some illustrative examples, the number of fiducial patterns 240 can be omitted.

Thus, the illustrative examples enables operating placement robots to place courses simultaneously in a manner that avoids collisions between the end effectors. In the illustrative examples, the end effectors have a configuration that enables picking up and placing courses with different orientations while avoiding collisions. Further, in the illustrative examples, a minimum spacing is provided such that courses can be simultaneously placed without collisions between end effectors.

Further, the illustrative examples provide patterns of fiducial markers that enable positioning at least one of the end effector or a course picked up by the end effector when used with a vision system. As result, increased accuracy in the placement of courses can be performed using the end effector in the different illustrative examples.

Also, the end effector has a vacuum system that can selectively apply vacuum to different segmented vacuum regions. These regions can be selected to correspond to the shape and dimensions of courses being picked up and placed by an end effector. In this manner, more efficient application of vacuum can occur in picking placing courses. As result, when courses with other shapes and dimensions are being picked up, the regions can be selected to correspond shapes and dimensions of those courses. As a result, greater flexibility was present in the end effector by using this vacuum system with different segmented vacuum regions.

The illustration of the composite manufacturing environment in the different components in that environment in FIGS. 1-2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, inspection system 170 may be omitted in some illustrative examples. And in other examples, inspection system 170 may be a separate component from course placement system 102. In another illustrative example, course placement system 102 can include other components such as a cutting system with conveyors and cutters.

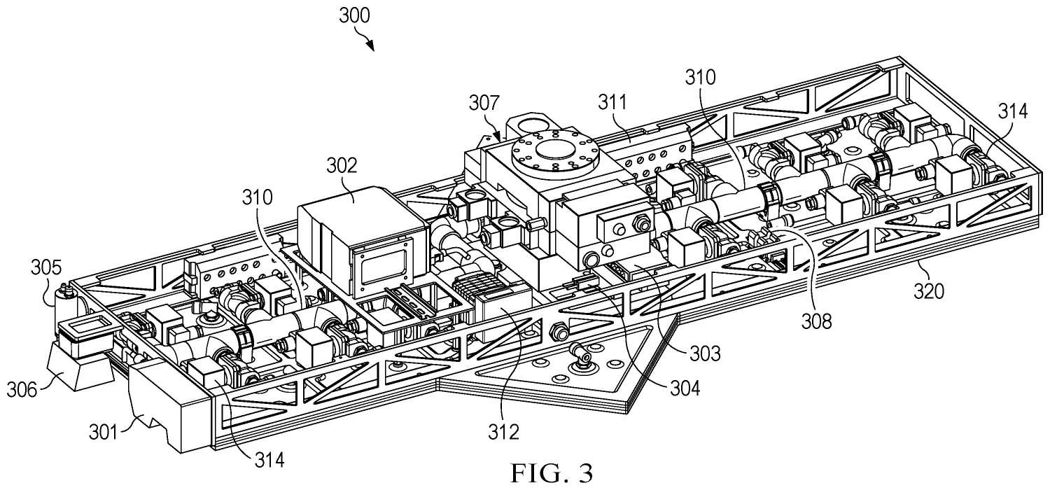

In reference next to FIG. 3, an illustration of an end effector 300 is shown in a perspective view and is an example of an implementation for end effector 174 and end effectors 122 in FIG. 1.

Some of the components for end effector 300 can be seen in this view. For example, end effector 300 includes profilometer 301 and profilometer controller 302. Profilometer 301 is an example of a sensor in inspection system 170 in FIG. 1 that can measure the contours of a surface to identify overlaps and gaps between courses.

Also depicted in this view are network switch 303, USB to ethernet connector 304, interface modules 307, thermal camera 305, and vision camera 306, and power distribution 308. These cameras are examples of cameras 172 in camera system 171 in FIG. 1. In this example, USB to ethernet connector 304 is used with thermal camera 305. Interface modules 307 are used as an interface to physical attachment, data, and power to a placement robot.

Also depicted in this view are vacuum manifolds 310, digital outputs 311, pneumatic valve manifold 312, and vacuum valves 314. These components are examples of components in a vacuum system such as vacuum system 230 in FIG. 2. Digital outputs 311 are digital outputs that are used to control vacuum valves 314.

Frame 320 is a structural component for end effector 300. The different components depicted are connected to frame 320. These different components can be connected directly or indirectly to frame 320. In other words, one component may be connected indirectly to frame 320 by being connected to another component that is directly connected to frame 320.

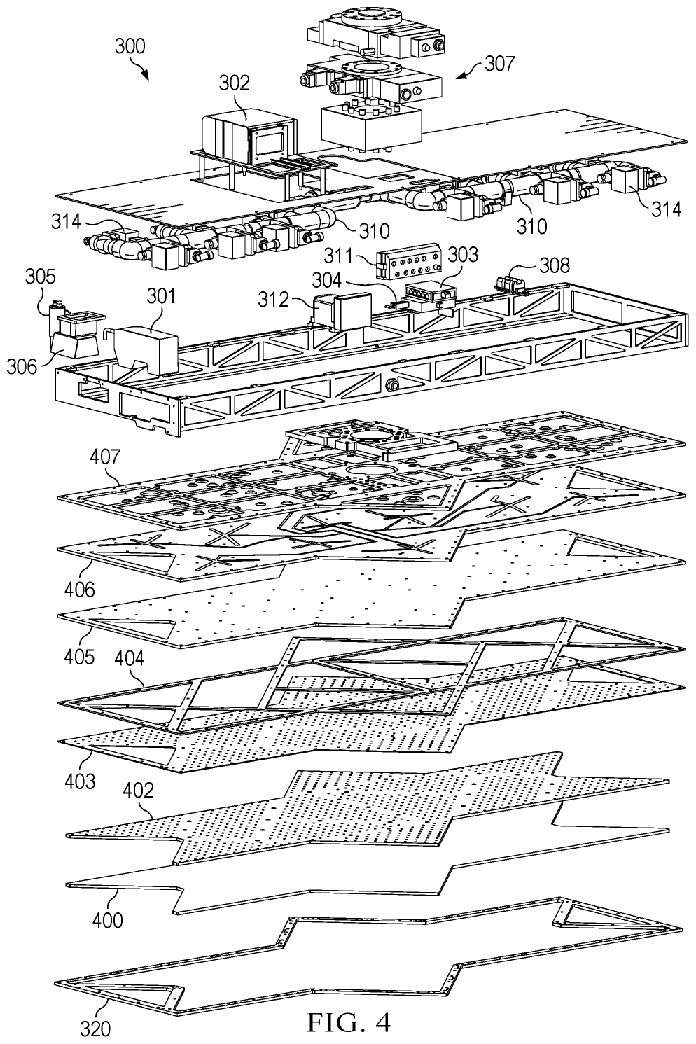

Turning now to FIG. 4, an illustration of an exploded view of end effector 300 is depicted in accordance with an illustrative embodiment. In this exploded view, a number of layers are shown. These layers include frame 320, contact surface layer 400, elastic layer 402, perforated plate 403, pocket plate 404, gasket cap 405, slotted gasket 406, and backplate 407. Also depicted in this view are stiffeners and mounting plates 408.

In this example, contact surface layer 400 is selected as a surface that can be used for vacuum applications. Additionally, this layer also provides a contact surface for courses.

Contact surface layer 400 can be comprised of a material that is porous, has perforations, or is both porous and has perforations that can distribute vacuum and air. This layer can be comprised of materials such as porous polyethylene, carbon fiber reinforced polymer, aluminum, latex, or other suitable material. In the illustrative example, contact surface layer 400 can include suction cups comprised of latex or polyurethane.

In this example, elastic layer 402 can provide an ability to conform to ply drops. Further, this layer can also be used to compact layers of courses. This layer can also mitigate robot deviations and movement. In one illustrative example, elastic layer 402 can be comprised of a foam, an elastomeric foam, rubber, latex, polyurethane foam, urethane, polytetrafluoroethylene, cotton, polyester, or other suitable materials.

Perforated plate 403 is a structural plate that can provide flatness for contact surface layer 400 and elastic layer 402. This component can also apply pressure to seal slotted gasket 406. Perforated plate 403 can be comprised of a material such as aluminum or other suitable materials that provide desired stiffness. In this illustrative example, the perforated plate can be comprised of materials selected from aluminum, steel, titanium, carbon fiber reinforced polymer, or other suitable materials.

In this illustrative example, pocket plate 404 is a structural component that defines vacuum pockets for regions or areas where vacuum can be applied. These areas of vacuum defined by the vacuum pockets can be selected to optimize picking up and holding courses with various orientations such as −45 degrees, 45 degrees, and 90 degrees, as well as other orientations. Pocket plate 404 is comprised of material such as a plastic polymer, high density polyethylene (HDPE) or other suitable materials.

In another illustrative example, the material can be the same material used for frame 320. Gasket cap 405 seals slotted gasket 406. Further, this component has openings with a size to control pressure and vacuum to lower layers in end effector 300 such as contact surface layer 400 and elastic layer 402. In this example, gasket cap 405 can be composite material such as a plastic polymer, a high density polyethylene (HDPE) or other suitable materials.

In this illustrative example, slotted gasket 406 is selected to distribute air and vacuum in the same manifold without the need for hoses. This component can be comprised of materials such as rubber, blend aramid fiber, Buna-N rubber, polyurethane, latex or other suitable materials.

Backplate 407 is a structural component and can provide a mounting surface for connecting other components. In this example, backplate 407 be comprised of aluminum, steel, titanium, carbon fiber reinforced polymer, or other suitable materials.

In this illustrative example, stiffeners and mounting plates 408 are components that can be used in stiffening end effector 300 and mounting other components. For example, lengthwise stiffeners in stiffeners and mounting plates 408 can reduce at least one of end effector sag or vibration amplitude, or vibration frequency. Mounting plates in stiffeners and mounting plates 408 can be used to attach end effector 300 to a placement robot. These mounting plates can also provide mounting surfaces for inspection devices such as thermal camera 305, vision camera 306, and profilometer 301. In this example, these components can be comprised of aluminum, steel, titanium, carbon fiber reinforced polymer, or other suitable materials.

The illustration of the different layers and components for end effector 300 in FIGS. 3-4 are provided as an example of one implementation for end effector 174 and end effectors 122. This illustration is not meant to limit the manner in which other illustrative examples can be implemented. For example, in some illustrative examples, backplate 407 can be considered part of frame 320. In another illustrative example, sensors such as thermal camera 305, and vision camera 306, and profilometer 301 can be omitted. In another example, vision camera 306 can be used without thermal camera 305.

Further, the materials specified for the different layers are provided as examples. Other materials that are suitable for the different functions provided by the layers can also be used in place of or in addition to the materials described. Additionally, in some illustrative examples, different layers can be comprised of one or more of the different materials listed and not merely a single material.

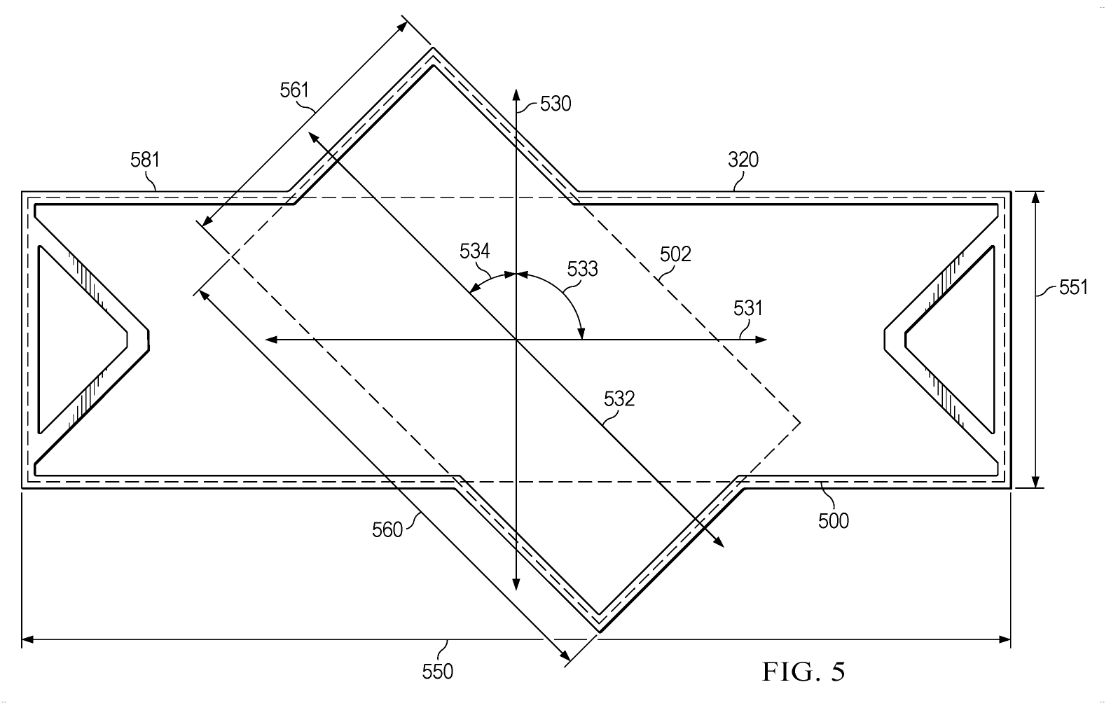

With reference next to FIG. 5, an illustration of a frame is depicted in accordance with an illustrative embodiment. In this example, a bottom view of frame 320 is depicted. In this bottom view, frame 320 has the shape of a six-cornered non-convex polygon such as a six pointed star. In this example, the six pointed star shape is a slanted six pointed star shape. In other illustrative examples, the slanted six pointed star shape of frame 320 may not be symmetrical or centered. Further, shapes other than a six pointed star shape may be used.

As depicted, frame 320 has first rectangular shape 500 and second rectangular shape 502 that overlaps first rectangular shape 500 at an angle to first rectangular shape 500. These partially overlapping shapes result in frame 320 having boundary 581 that forms a six-cornered non-convex polygon such as a six pointed star.

In this illustrative example, reference axis 530 extends through frame 320. As depicted in this example, this reference axis is for frame 320. In another illustrative example, reference axis 530 can be offset to one side of frame 320.

First longitudinal axis 531 extends centrally through first rectangular shape 500. In this example, first longitudinal axis 531 intersects reference axis 530 at first angle 533. In this example, first angle 533 is 90 degrees.

Second longitudinal axis 532 extends centrally through second rectangular shape 502. As depicted, second longitudinal axis 532 intersects reference axis 530 at second angle 534. In this example, second angle 534 is 45 degrees.

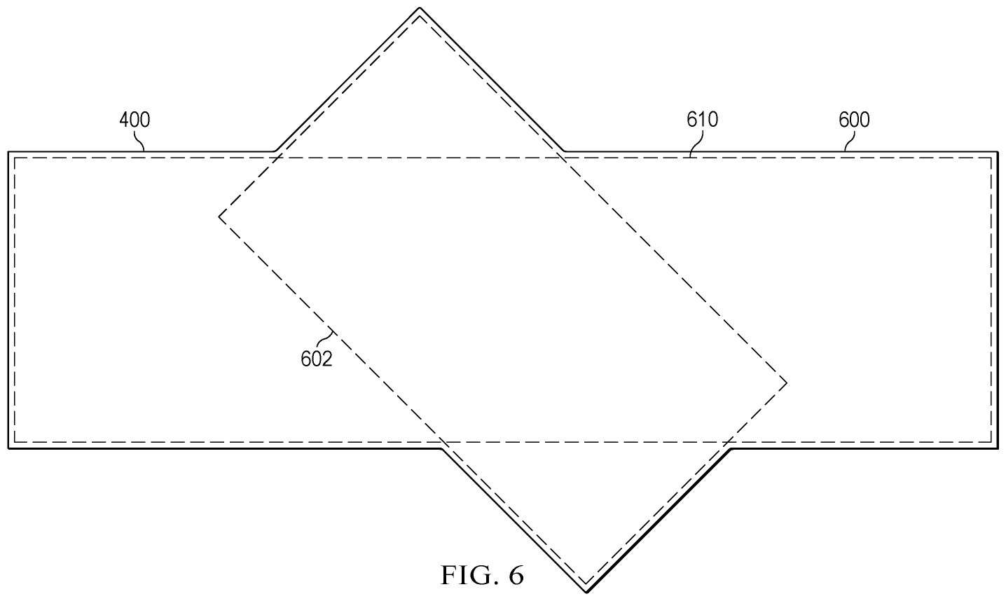

Turning next to FIG. 6, an illustration of a contact surface layer is depicted in accordance with an illustrative embodiment. In this example, a bottom view of contact surface layer 400 is shown. In this bottom view, contact surface layer 400 has boundary 610 that has a shape of a six pointed star. In this example, the six pointed star shape is a slanted six pointed star shape.

In this illustrative example, contact surface layer 400 has first rectangular shape 600 and second rectangular shape 602 that partially overlaps first rectangular shape 500 at an angle to first rectangular shape 500 with boundary 610 in the shape of a slanted six pointed star shape. In this example, first rectangular shape 600 defines an area that can be used to pick and place a 45 degree course. Second rectangular shape 602 defines an area that can be used to pick and place a 90 degree course in this example.

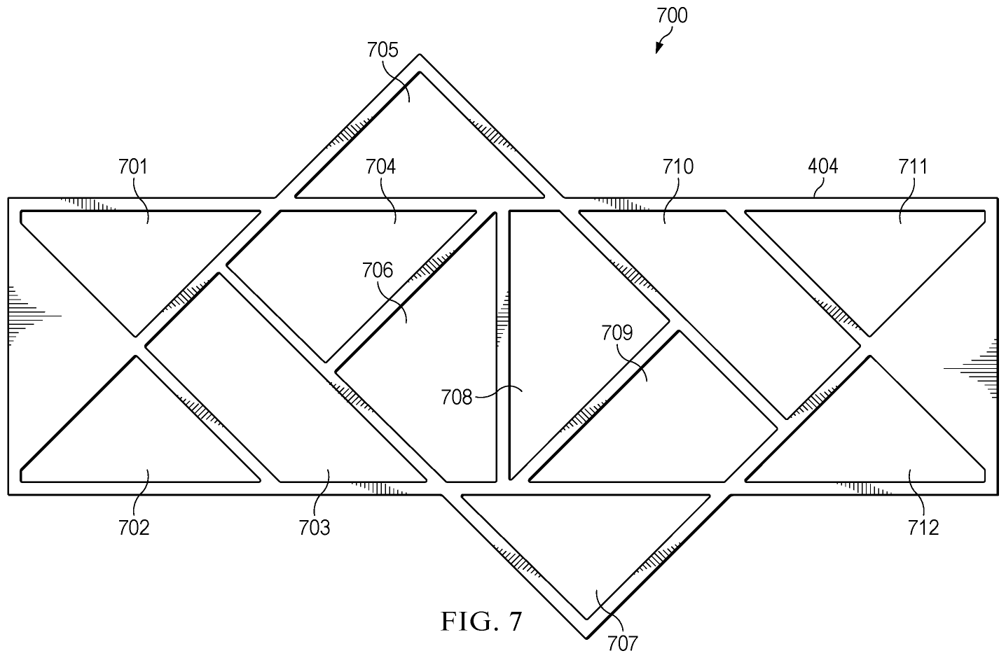

Next in FIG. 7, an illustration of a pocket plate is depicted in accordance with an illustrative embodiment. In this example, the bottom view of pocket plate 404 is shown. In this bottom view, pocket plate 404 defines vacuum pockets 700. As depicted, vacuum pockets 700 are comprised of pocket 701, pocket 702, pocket 703, pocket 704, pocket 705, pocket 706, pocket 707, pocket 708, pocket 709, pocket 710, pocket 711, and pocket 712.

The illustration of this arrangement of shapes of vacuum pockets for segmentation is only an example. Other types of segmentation configurations can be used in other illustrative examples.

In another illustrative example, suction cups can be used in pocket plate 404 in place of or in addition to a porous layer of material. Further, in implementing pocket plate 404 with suction cups, one or more check valves can be used with each pocket that allows that pocket to be turned off passively if the material being picked up does not extend over that pocket.

In the illustrative example, a vacuum system can selectively apply a vacuum to different pockets. In addition to applying a vacuum, these pockets can also apply a positive air pressure to drop the course. The pockets can be selected to correspond to the shape and dimensions of the course that is to be picked and placed.

In this example, the number of pockets and their shapes have been selected to optimize picking and placing courses that have an orientation of +45 degrees, −45 degrees, and 90 degrees.

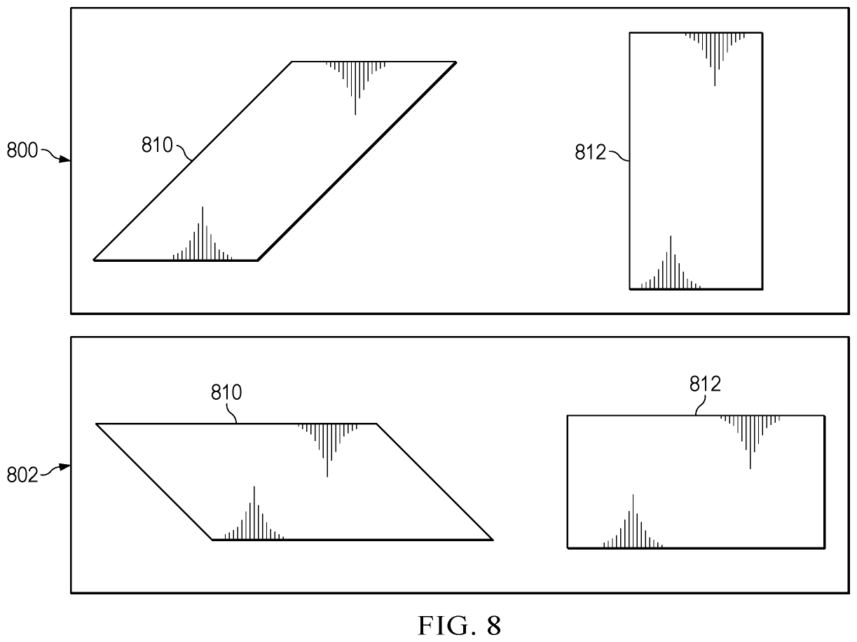

With reference next to FIG. 8, an illustration of course orientations is depicted in accordance with an illustrative embodiment. In the illustrative example, course orientations include pickup orientation 800 and layup orientation 802.

In this illustrative example, course 810 is picked up in pickup orientation 800, which is a 45 degree pick up by end effector 300. Course 810 is rotated and placed onto a layout surface in layup orientation 802.

In this example, course 810 can be picked up by end effector 300 with first rectangular shape 600 of contact surface layer 400. The pickup can be performed by using a vacuum applied to selected vacuum pockets in pocket plate 404 that are selected to correspond to the shape and dimensions of course 810. In this example, end effector 300 rotates course 810 for placement in layup orientation 802.

Course 812 is picked up in pickup orientation 800, which is a 45 degree pick up by end effector 300. Course 810 is rotated and placed in layup orientation 802.

In this example, course 812 can be picked up by end effector 300 with second rectangular shape 602 of contact surface layer 400. This pickup can be performed by using a vacuum applied to selected vacuum pockets in pocket plate 404 that are selected to correspond to the shape and dimensions of course 812. In this example, end effector 300 rotates course 812 for placement onto the layup surface in layup orientation 802.

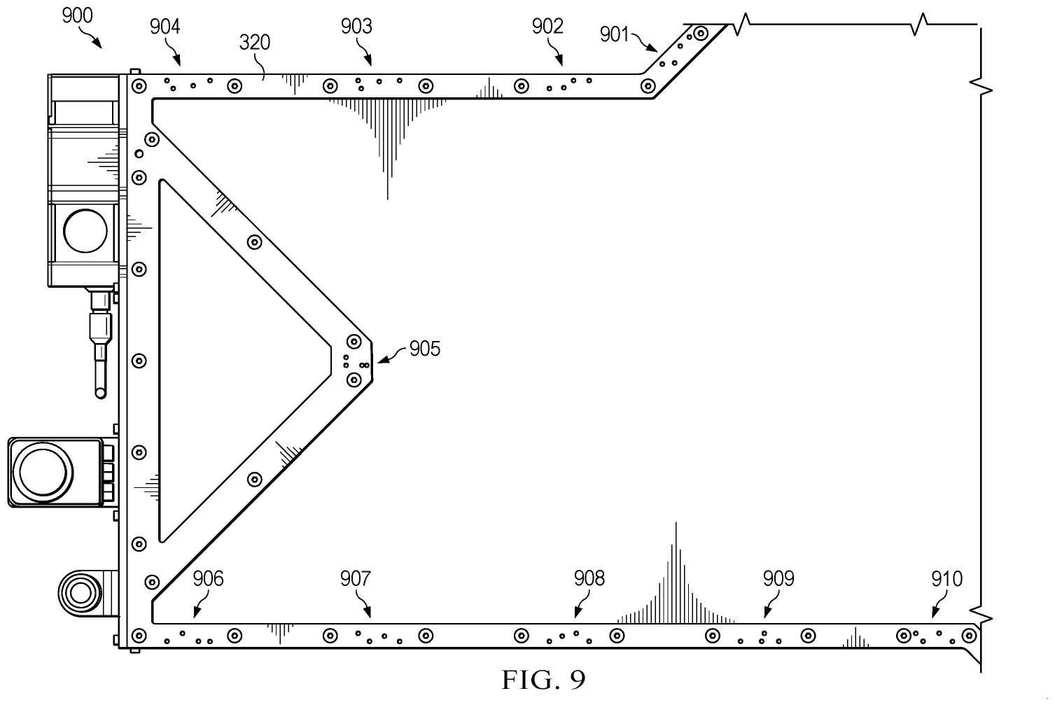

Turning next to FIG. 9, an illustration of fiducial patterns is depicted in accordance with an illustrative embodiment. In this illustrative example, an enlarged view of a portion of frame 320 is shown such that fiducial patterns 900 on frame 320 can be seen. In this example, fiducial patterns 900 are formed from groupings of dots.

In this view, fiducial patterns 900 include fiducial pattern 901, fiducial pattern 902, fiducial pattern 903, fiducial pattern 904, fiducial pattern 905, fiducial pattern 906, fiducial pattern 907, fiducial pattern 908, fiducial pattern 909, and fiducial pattern 910.

Each one of these patterns of dots in fiducial patterns 900 are unique. Although the same number of dots are used, the spacing and positioning of these dots relative to each other are unique for each pattern. In other examples, barcodes, QR codes, block patterns, a protagonist, or other visual cues can be used.

In this example, these fiducial patterns can provide localized coordinate system in reference to an end effector coordinate system. Further, these fiducial patterns can also include information that allows these patterns to be uniquely identified and located. For example, the spacing of dots may be used to identify the location of the pattern on end effector 300.

Fiducial patterns 900 enable visually locating a course relative to known geometry on end effector 300. Further, the position of the course on end effector 300 can also be determined using these fiducial patterns. Further, fiducial patterns 900 can be used to adjust the replacement robot center point for a measured course location deviation before placement of the course.

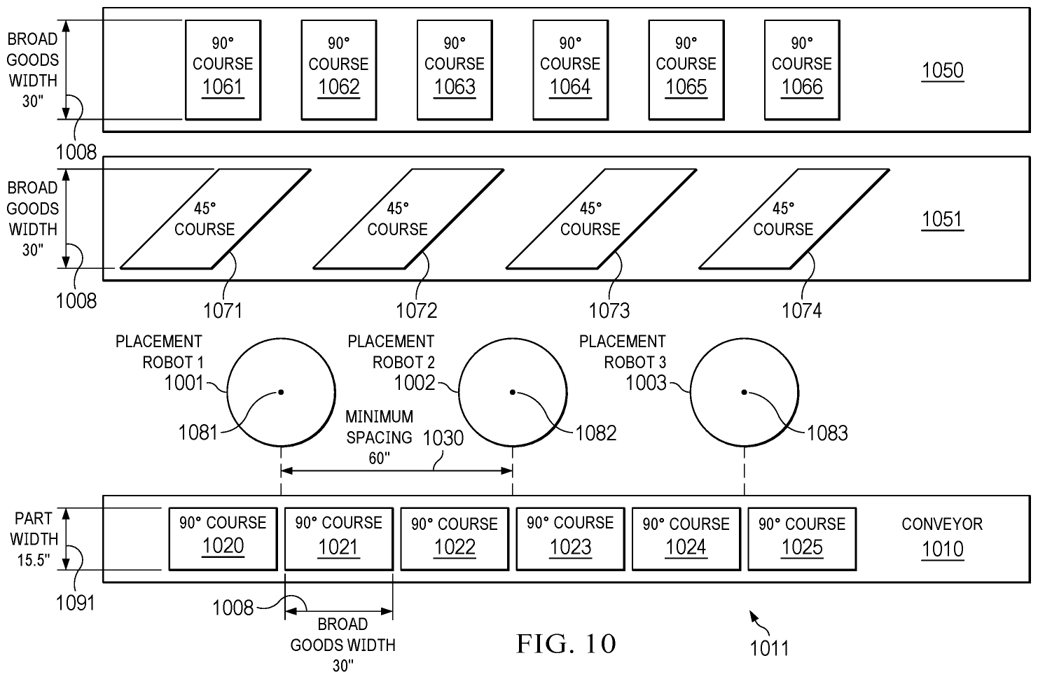

Next in FIG. 10, a schematic illustration of spacing of placement robots is depicted in accordance with an illustrative embodiment. In this illustrative example, placement robot 1 1001, placement robot 2 1002, and placement robot 3 1003 are positioned in an array.

These placement robots pick up courses from pickup conveyor 1050 and pickup conveyor 1051. As depicted, 90° courses such as 90° course 1061, 90° course 1062, 90° course 1063, 90° course 1064, 90° course 1065, and 90° course 1066, are located on pickup conveyor 1050. In this illustrative example, 45° courses, such as 45° course 1071, 45° course 1072, 45° course 1073, and 45° course 1074, are located on pickup conveyor 1051. The courses have broad goods width 1008, which is 30 inches in this example. Broad goods are a length of material from which courses are cut. Broad goods can typically be material in a roll. In this example, broad goods width 1008 is the width of the material from which the courses are cut.

These placement robots are spaced to enable placing courses on layup conveyor 1010 using end effector 300 in a manner that avoids collisions during simultaneous placement of the courses onto layup conveyor 1010 by these placement robots, specifically as the end effectors are rotated and moved through space by the robots as courses are picked up and placed.

In this illustrative example, placement robot spacing is a function of the broad goods width 1008 and the number of courses that each placement robot places. In this example, each placement robot places two 90° courses onto layup conveyor 1010 to form ply 1011. For example, placement robot 1 1001 places 90° course 1020 and 90° course 1021 onto layup conveyor 1010. Placement robot 2 1002 places 90° course 1022 and 90° course 1023 onto layup conveyor 1010, and placement robot 3 1003 places 90° course 1024 and 90° course 1025 onto layup conveyor 1010.

In this example, the placement of courses is performed as a two pass layup. In other words, the placement robots simultaneously place one set of courses (a first pass) and then simultaneously place another set of courses (a second pass). For example, 90° course 1020, 90° course 1022, and 90° course 1024 are first spaced courses that are placed simultaneously onto layup conveyor 1010 by placement robot 1 1001, placement robot 2 1002, and placement robot 3 1003 in the first pass. 90° course 1021, 90° course 1023, and 90° course 1025 are first spaced courses that are placed simultaneously onto layup conveyor 1010 by placement robot 1 1001, placement robot 2 1002, and placement robot 3 1003 in the second pass to form ply 1011.

In this illustrative example, the spacing between placement robot 1 1001, placement robot 2 1002, and placement robot 3 1003 is minimum spacing 1030 between the center points of these placement robots. In this example, placement robot spacing is a function of broad goods width 1008 and the number of courses that each placement robot places. Additionally, minimum spacing 1030 between placement robots that avoids collisions in performing a simultaneous placement of courses can based on a peripheral shape of the frame and dimensions of the peripheral shape of the frame.

In one example, the center point can be the center of the base of the placement robot. In this illustrative example, the center point of a placement robot is the center of rotation of the first axis of the placement robot. In one illustrative example, the center point can be the center of a base of the robots through which the first axis of rotation extends.

With this example, broad goods width 1008 is 30 inches and represents the width of the material that is cut to form the course, such as a width or a roll of fabric or prepreg. This width is also the length of the courses when placed on layup conveyor 1010 to form ply 1011. Further in this example, the part is a stringer having a part width 1091 of 15.5 inches.

When placing two courses, minimum spacing 1030 for the placement robots is 60 inches when broad goods width 1008 is 30 inches. The use of end effectors as described in the different illustrative examples enable this spacing in the placement of courses simultaneously in two passes without collisions between the end effectors used by these placement robots.

Center points for the placement robots are spaced by the number of courses being placed (usually 2) multiplied by the length of the long edge of the end effector picking up 90's (30″) resulting in a 60″ spacing. A center point is the axis of rotation about the first motor axis of a placement robot. The short end is the composite layup width such as a stringer with a 15.5″ width.

In this, the center point of each placement robots is lined up between the courses placed by the placement robots. For example, center point 1081 for placement robot 1001 is aligned between 90° course 1020 and 90° course 1021; center point 1082 for placement robot 1002 is aligned between 90° course 1022 and 90° course 1023; and center point 1083 for placement robot 1003 is aligned between 90° course 1024 and 90° course 1025.

Additionally, the broad goods width of the course can determine the end effector size in addition to robot spacing. In this example, the end effector size and placement robot spacing are both a function of the course width.

For example, the dimensions of end effectors can also be based off broad goods width 1008. Referring back to FIG. 5, the boundary of frame 320 for end effector 300 is based off broad goods width 1008, course angle, and the part width in this example. In this example, the course angle is the 45 degree and the part is a stringer with a part width of 15.5 inches.

Length 550 of first rectangular shape 500 can be represented as:

PartWidth/tan(course angle))+(BroadGoodsWidth/cos(course angle).

where PartWidth is the part width, course angle is the angle of the course cut from the broad goods, BroadGoodsWidth is the width of the broad goods. BroadGoodsWidth is a width of the broad goods from which courses are cut.

In this example, course angle can be 0<course angle <90. With negative angles from 0 to −90, the absolute value can be used. Length 550 is 57.926 inches when the broad goods width is 30 inches, the part width (stringer) is 15.5 inches, and the course angle is 45 degrees.

Also, width 551 of first rectangular shape 500 can be selected based on the width of the part, which a stringer width in this example. The stringer width is 15.5 inches. Width 551 is set to 15.5 inches.

In this example, length 560 of second rectangular shape 502 is broad goods width 1008. In this example, length 560 is 30 inches and width 561 of second rectangular shape 502 is the width of the stringer, which is 15.5 inches.

In this example, length 560 of second rectangular shape 502 is equal to broad goods width 1008. length 560 can be used to set minimum spacing 1030 for the placement robots because it is based on broad goods width 1008.

Thus, in this depicted example, a first rectangular shape for the frame of an end effector has a length and a width. The length of the end effector is the length of the first rectangular shape. This length is based on the broad goods width of the broad goods from which the courses are cut. The length can also be based on the course angle for the course and a width of the part. In this example, the length of the first rectangular shape can be used to set a minimum spacing between the placement robots.

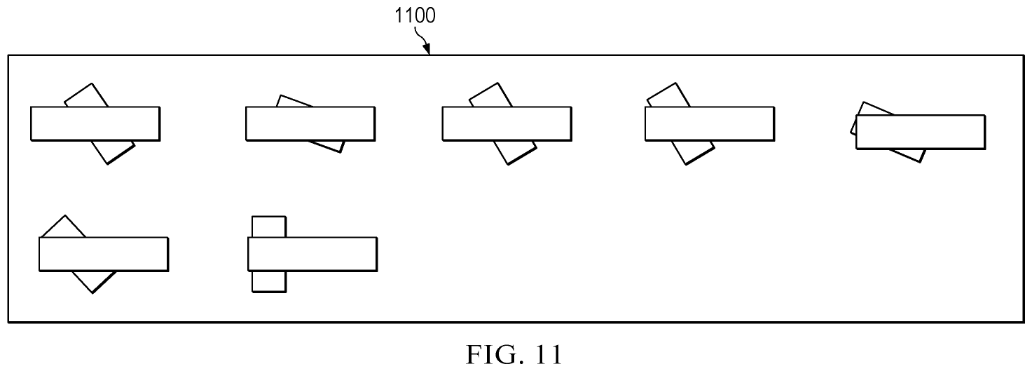

With reference now to FIG. 11, an illustration of end effector shapes is depicted in accordance with an illustrative embodiment. In this illustrative example, end effector shapes 1100 are examples of shapes for end effector 174 in FIG. 1 and FIG. 2 that can be formed by first rectangular shape 202 and second rectangular shape 203 partially overlapping the first rectangular shape 202.

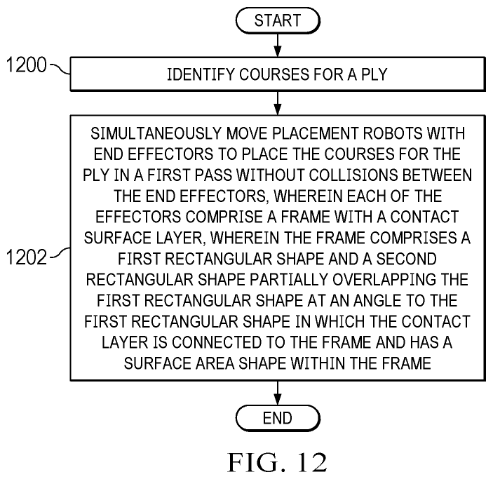

Turning next to FIG. 12, an illustration of a flowchart of a process for placing courses is depicted in accordance with an illustrative embodiment. The process in FIG. 12 can be using placement robots 120 and end effectors 122 in course placement system 102 in FIGS. 1-2.

The process identifies courses for a ply (operation 1200). The process simultaneously moves placement robots with end effectors to place the courses for the ply in a first pass without collisions between the end effectors, wherein each of the end effectors comprises a frame with a contact surface layer, wherein the frame comprises a first rectangular shape and a second rectangular shape partially overlapping the first rectangular shape at an angle to the first rectangular shape in which the contact layer has a surface area shape within the frame (operation 1202). The process terminates thereafter.

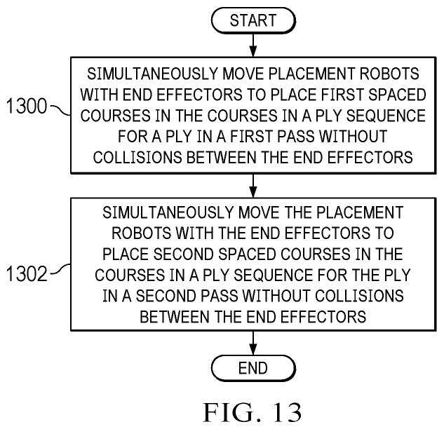

With reference to FIG. 13, an illustration of a flowchart of a process for simultaneously moving placement robots with end effectors is depicted in accordance with an illustrative embodiment. The process in this figure is an example of an implementation of operation 1202 in FIG. 12.

The process simultaneously moves placement robots with end effectors to place first spaced courses in the courses in a ply sequence for a ply in a first pass without collisions between the end effectors (operation 1300). In this example, the ply sequence is the order in which courses are placed to form the ply. The process simultaneously moves the placement robots with the end effectors to place second spaced courses in the courses in the ply sequence for the ply in a second pass without collisions between the end effectors (operation 1302). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

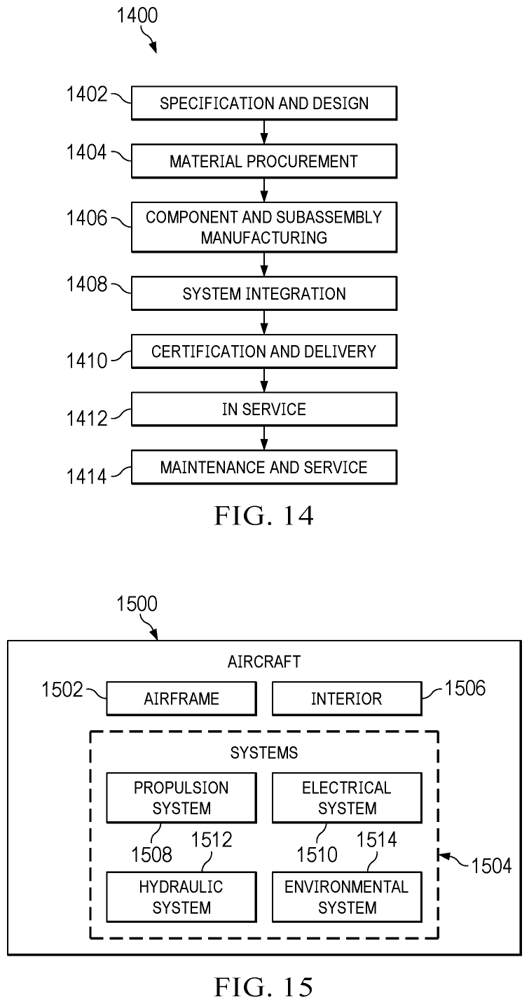

Illustrative embodiments of the disclosure may be described in the context of aircraft manufacturing and service method 1400 as shown in FIG. 14 and aircraft 1500 as shown in FIG. 15. Turning first to FIG. 14, an illustration of an aircraft manufacturing and service method is depicted in accordance with an illustrative embodiment. During pre-production, aircraft manufacturing and service method 1400 may include specification and design 1402 of aircraft 1500 in FIG. 15 and material procurement 1404.

During production, component and subassembly manufacturing 1406 and system integration 1408 of aircraft 1500 in FIG. 15 takes place. Thereafter, aircraft 1500 in FIG. 15 can go through certification and delivery 1410 in order to be placed in service 1412. While in service 1412 by a customer, aircraft 1500 in FIG. 15 is scheduled for routine maintenance and service 1414, which may include modification, reconfiguration, refurbishment, and other maintenance or service.

Each of the processes of aircraft manufacturing and service method 1400 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 15, an illustration of an aircraft is depicted in which an illustrative embodiment may be implemented. In this example, aircraft 1500 is produced by aircraft manufacturing and service method 1400 in FIG. 14 and may include airframe 1502 with plurality of systems 1504 and interior 1506. Examples of systems 1504 include one or more of propulsion system 1508, electrical system 1510, hydraulic system 1512, and environmental system 1514. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1400 in FIG. 14.

In one illustrative example, components or subassemblies produced in component and subassembly manufacturing 1406 in FIG. 14 can be fabricated or manufactured in a manner similar to components or subassemblies produced while aircraft 1500 is in service 1412 in FIG. 14. As yet another example, one or more apparatus embodiments, method embodiments, or a combination thereof can be utilized during production stages, such as component and subassembly manufacturing 1406 and system integration 1408 in FIG. 14. One or more apparatus embodiments, method embodiments, or a combination thereof may be utilized while aircraft 1500 is in service 1412, during maintenance and service 1414 in FIG. 14, or both. The use of a number of the different illustrative embodiments may substantially expedite the assembly of aircraft 1500, reduce the cost of aircraft 1500, or both expedite the assembly of aircraft 1500 and reduce the cost of aircraft 1500.

For example, the use of end effectors in the different illustrative examples can increase the speed at which courses are laid up to form plies for charges that are used for parts in component and subassembly manufacturing 1406. Further, the amount of time needed to create parts for use in maintenance and service 1414 can also be reduced.

Thus, the illustrative examples provide a method, apparatus, system for placing courses. In the different illustrative examples, an increased clearance is present between end effectors as compared to current end effectors using placement robots with the same spacing between. Further, placement robots can place courses simultaneously in a manner that avoids collisions between the end effectors factors. In the illustrative examples, the end effectors have a configuration that enables picking up and placing courses with different orientations while avoiding collisions. In the illustrative examples, a minimum spacing is provided such that courses can be placed in a two pass process.

Also, the illustrative examples provide patterns of fiducial markers that enable positioning at least one of the end effector or a course picked up by the end effector when used with a vision system. As result, increased accuracy in the placement of courses can be performed using the end effector in the different illustrative examples.

In the illustrative examples, the end effector has a vacuum system that can selectively apply vacuum to different segmented vacuum regions. These regions can be selected to correspond to the shape and dimensions of courses being picked up and placed by an end effector. In this manner, more efficient application of vacuum can occur in picking placing courses.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A course placement system comprising:
a frame comprising a first rectangular shape and a second rectangular shape partially overlapping the first rectangular shape at an angle to the first rectangular shape; and
a contact surface layer connected to the frame, wherein the contact surface layer has a surface area shape within the frame.

2. The course placement system of claim 1 further comprising:
a reference axis extending through the frame;
a first longitudinal axis extending centrally though the first rectangular shape, wherein the first longitudinal axis intersects the reference axis at a first angle; and
a second longitudinal axis extending centrally though the second rectangular shape, wherein the second longitudinal axis intersects the reference axis at a second angle.

3. The course placement system of claim 2, wherein the first angle is 90 degrees and the second angle is 45 degrees.

4. The course placement system of claim 3, wherein the first rectangular shape is configured to pick and place 90 degree courses and the second rectangular shape is configured to pick and place one of 45 degrees courses, −45 degree courses, and 0 degree courses.

5. The course placement system of claim 1, wherein the contact surface layer has a boundary with a shape of a six pointed star.

6. The course placement system of claim 1 further comprising:
a vacuum system having segmented vacuum regions.

7. The course placement system of claim 1 further comprising:
an elastic layer.

8. The course placement system of claim 1 further comprising:
a number of fiducial patterns.

9. The course placement system of claim 1, further comprising:
a placement robot connected to the frame;
a camera system configured to generate a number of images of an end effector holding a course; and
a computer system configured to:
analyze the number of images for positioning of the course that is out of a tolerance; and
control the placement robot to change the positioning of the course in response to the course having a positioning that is out of the tolerance.

10. The course placement system of claim 1, further comprising:
a placement robot connected to the frame;
a camera system configured to generate a number of images of an end effector holding a course; and
a computer system configured to:
analyze the number of images for an anomaly in the course that is out of a tolerance; and
control the placement robot to move the course to a scrap location in response to the course having the anomaly that is out of the tolerance.

11. The course placement system of claim 1, wherein the second rectangular shape has a length and a width and wherein the length is based on a broad goods width from which the courses are cut.

12. The course placement system of claim 1, wherein the first rectangular shape has a length and a width and wherein the length is determined as follows:
PartWidth/tan(course angle))+(BroadGoodsWidth/cos(course angle)
where PartWidth is a part width and course angle is the angle of a course cut from broad goods and BroadGoodsWidth is a width of broad goods from which courses are cut.

13. A course placement system comprising:
placement robots; and
end effectors connected to the placement robots, wherein each of the end effectors comprises:
a frame comprising a first rectangular shape and a second rectangular shape partially overlapping the first rectangular shape at an angle to the first rectangular shape that forms a six pointed star shape; and
a contact surface layer connected to the frame, wherein the contact surface layer has a surface area shape within the frame.

14. The course placement system of claim 13, wherein the placement robots have a minimum spacing between each other that avoids collisions in performing a simultaneous placement of courses based on a peripheral shape of the frame and dimensions of the peripheral shape of the frame.

15. The course placement system of claim 13, wherein the end effectors have an end effector clearance between the end effectors during a simultaneous placement of courses by the placement robots, wherein the end effector clearance is based on dimensions of the surface area shape of the end effectors.

16. The course placement system of claim 15, wherein the simultaneous placement of the courses onto a layup surface for a ply occurs in two passes.

17. The course placement system of claim 13 further comprising:
a controller in communication with the placement robots, wherein the controller is configured to:
control the placement robots to perform a simultaneous placement of courses onto a layup surface with a spacing of the placement robots that provides an end effector clearance that avoids collisions between the end effectors during the simultaneous placement of the courses onto the layup surface.

18. The course placement system of claim 17, wherein the courses are placed on the layup surface in a two pass layup of the courses to form a ply.

19. The course placement system of claim 18, wherein in controlling the placement robots, the controller is configured to control the placement robots to:
pickup the courses in an initial orientation;
change the courses from the initial orientation to a layup orientation; and
place the courses onto the layup surface in the layup orientation.

20. The course placement system of claim 13, wherein the first rectangular shape is configured to pick and place 90 degree courses and the second rectangular shape is configured to pick and place one of 45 degrees courses, −45 degree courses, and 0 degree courses.

21. The course placement system of claim 13, wherein the second rectangular shape has a length and a width and wherein the length is based on a broad goods width from which the courses are cut.

22. The course placement system of claim 21, wherein the length of the second rectangular shape is used to set a minimum spacing between the placement robots.

23. The course placement system of claim 13, wherein the first rectangular shape has a length and a width and wherein the length is determined as follows:
PartWidth/tan(course angle))+(BroadGoodsWidth/cos(course angle)
where PartWidth is a part width and course angle is the angle of a course cut from broad goods and BroadGoodsWidth is a width of broad goods from which courses are cut.

24. A method for placing courses, the method comprising:
identifying the courses for a ply; and
simultaneously moving placement robots with end effectors to place the courses for the ply in a first pass without collisions between the end effectors, wherein each of the end effectors comprises a frame with a contact surface layer, wherein the frame comprises a first rectangular shape and a second rectangular shape partially overlapping the first rectangular shape at an angle to the first rectangular shape in which the contact surface layer is connected to the frame and has a surface area shape within the frame.

25. The method of claim 24, wherein simultaneously moving the placement robots with the end effectors comprises:
simultaneously moving the placement robots with the end effectors to place first spaced courses in the courses in a ply sequence for the ply in a first pass without the collisions between the end effectors; and
simultaneously moving the placement robots with the end effectors to place second spaced courses in the courses in the ply sequence for the ply in a second pass without the collisions between the end effectors.

26. The method of claim 24, wherein the first rectangular shape is configured to pick and place 90 degree courses and the second rectangular shape is configured to pick and place 45 degree or −45 degree or 0 degree courses.
